(19) United States
(12) Patent Application Publication
(10) Pub. No.: US 2005/0144762 A1
(43) Pub. Date: Jul. 7, 2005

(54) Strap-length-adjusting device

(76) Inventor: Jinn-Yih Wang, Changhua County (TW)

Correspondence Address: BACON & THOMAS, PLLC, 625 SLATERS LANE, FOURTH FLOOR, ALEXANDRIA, VA, 22314, US

(21) Appl. No.: 10/749,561

(22) Filed: Jan. 2, 2004

(51) Int. Cl. F16G 11/00

(52) U.S. Cl. 24/136 R

(57) ABSTRACT

A strap-length-adjusting device is composed of a main body, a strap body, and at least one partition. The main body includes a vertical through hole and at least one horizontal hole, which communicate with each other. The strap body is overlapped itself to run through the vertical through hole and has two parts pulled out of two ends of the horizontal through hole. The partition that is identical to the horizontal through hole in number is mounted on the main body to form two fenders at two ends of the horizontal through hole. The two parts of the strap body are retarded respectively by the two fenders from being pulled back inside the main body. Accordingly, the two parts of the strap body are pulled out of the horizontal through hole to adjust the length of the strap body.

### BACKGROUND OF THE INVENTION

1. Field of the Invention

The present invention relates generally to apparatuses of adjusting the length of straps, and more particularly to a strap-length-adjusting device.

2. Description of the Related Art

Common straps for hanging name tags, whistles or other items in daily life have been appropriately lengthened to accommodate various situations or users of different statures after they are manufactured; however, it is very inconvenient to wear the lengthened strap for the user. Thus, the user usually knots the lengthened strap to shorten the strap. Although knotting the strap is not difficult, the knotted strap incurs inaesthetic appearance. Moreover, when the user intends to re-adjust the length of the strap to unknot the strap, it is difficult and troublesome to unknot the strap.

### SUMMARY OF THE INVENTION

The primary objective of the present invention is to provide a strap-length-adjusting device which can adjust the length of a strap conveniently and rapidly.

The secondary objective of the present invention is to provide a strap-length-adjusting device which can keep aesthetic appearance after adjusting the length of the strap.

Another objective of the present invention is to provide a strap-length-adjusting device which can hang light items, such as name tags, whistles, mobile phones, etc.

The foregoing objectives of the present invention are attained by the strap-length-adjusting device that is composed of a main body, a strap body, and at least one partition. The main body includes a vertical through hole and at least one horizontal hole, which communicate with each other. The strap body is overlapped itself to run through the vertical through hole and has two parts pulled out of two ends of the horizontal through hole. The partition that is identical to the horizontal through hole in number is mounted on the main body to form two fenders at two ends of the horizontal through hole. The two parts of the strap body are retarded respectively by the two fenders from being pulled back inside the main body. Accordingly, the two parts of the strap body are pulled out of the horizontal through hole to adjust the length of the strap body.

### BRIEF DESCRIPTION OF THE DRAWINGS

FIG. 1 is a perspective view of a first preferred embodiment of the present invention;

FIG. 2 is an inverted perspective view of the first preferred embodiment of the present invention, showing that a partition has no concavity and no convexity is formed at any of the two chutes;

FIG. 3 is a sectional view of the first preferred embodiments of the present invention;

FIG. 4 is a schematic view of the first preferred embodiments of the present invention in use;

FIG. 5 is a perspective view of a second preferred embodiment of the present invention;

FIG. 6 is a sectional view of the second preferred embodiment of the present invention in use; and

FIG. 7 is a perspective view of a third preferred embodiment of the present invention.

### DETAILED DESCRIPTION OF THE INVENTION

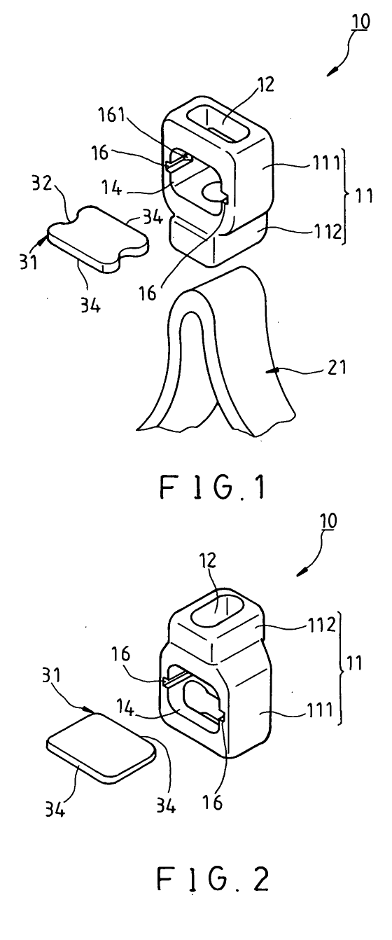

Referring to FIGS. 1-4, a strap-length adjusting device 10 constructed according to a first preferred embodiment of the present invention is composed of a main body 11, a strap body 21, and at least one partition 31.

The main body 11 is hollow inside and includes a vertical through hole 12 and at least one horizontal through hole 14 in communication with the vertical through hole 12. The main body 11 is formed of a flat-pillar-shaped first torso 111 and a flat-pillar-shaped second torso 112 that is positioned under the first torso 111 and has a long axle perpendicular to that of the first torso 111. The vertical through hole 12 runs through the first and second torsos 111 and 112 to have two rectangular outlets positioned respectively at a top end of the first torso 111 and a bottom end of the second torso 112 and having long axles perpendicular to each other. Two chutes 16 are recessed respectively at two sides of the horizontal through hole 14 of the main body 11 and a convexity 161 is formed at at least one of the two chutes 16.

The strap body 21 is overlapped itself to run through the perpendicular through hole 12 and has two parts pulled respectively out of two ends of the horizontal through hole 14.

The partition 31 which is embodied as a plate member is embedded into the chutes 16 at two ends thereof and includes at least one concavity 32 corresponding to the convexity 161 at a side thereof for securely positioning the partition 31, thereby forming two fenders 34 at the two ends of the horizontal through hole 14 to prevent the two parts of the strap body 21 from pulling back inside the main body 11. Alternatively, as shown in FIG. 2, none of the convexity 161 is formed at any of the two chutes 16 and none of the concavity 32 is formed at any of the two ends of the partition 31. The two chutes 16 are preferably narrowed to fixedly clamp the inserted partition. Alternatively, the two chutes 16 can be filled with super glue to fixedly secure the inserted partition 31.

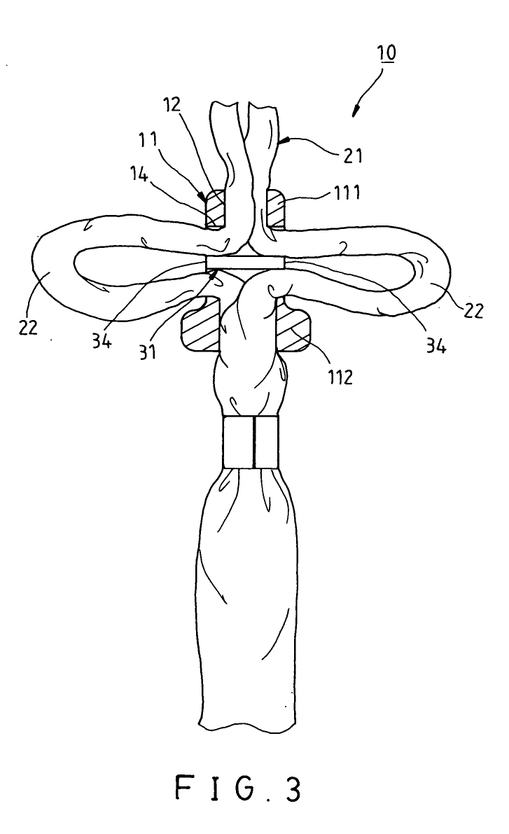

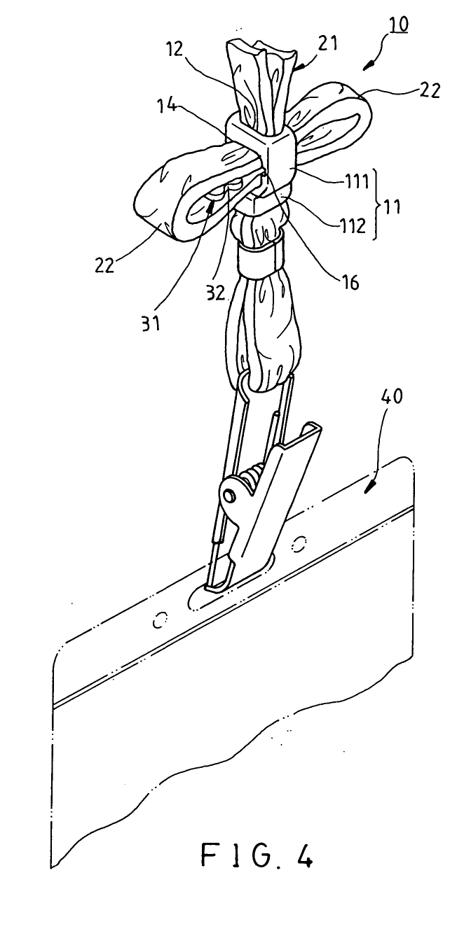

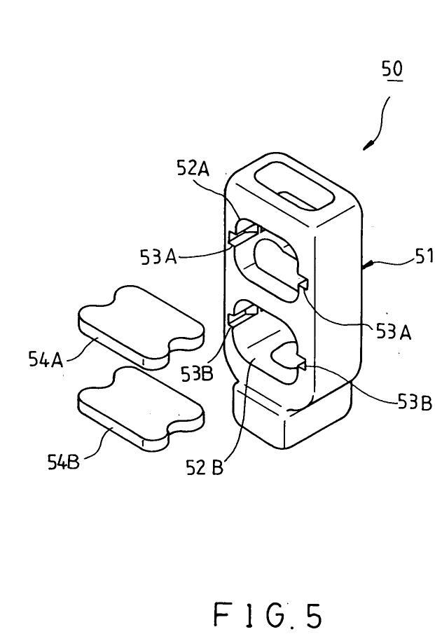

Referring to FIGS. 3-4, the strap body 21 of the strap-length-adjusting device 10 is inserted through a bottom end of the vertical through hole 12, into the main body 11, and out of a top end of the vertical through hole 12, and the two parts thereof are pulled respectively out of the two ends of the horizontal through hole 14 for a predetermined length to form a bowknot 22, and then the partition 31 is embedded into the two chutes 16. The user can adjust the size of the bowknot 22 to further adjust the length of the strap body 21. Because the two outlets of the vertical through hole 12 are rectangular and the two long axles thereof are perpendicular to each other, when the strap body 21 hangs a name tag 40 at a distal end thereof, the strap body 21 can be smoothly hung on the user's neck at wide surfaces thereof and the name tag 40 can naturally smoothly lie over the user's chest without random turning. In addition, the vertical and horizontal through holes 12 and 14 preferably fit the size of the strap body 21 to generate proper frictional resistance between the through holes 12 and 14 and the strap body 21 to prevent the two parts of the strap body 21 from being subject to slidably move, such that the present invention can bear a name tag, a whistle, or other light items. It needs only a tiny force exerted by the user to pull the bowknot 22 to easily adjust the length of the strap body 21.

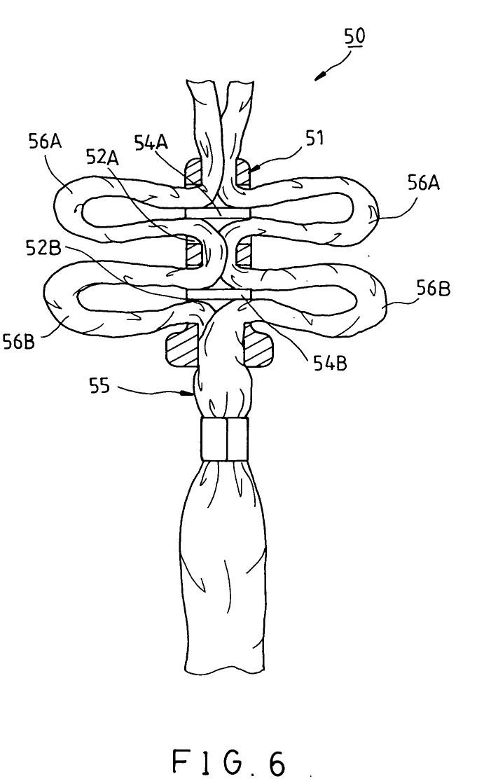

As shown in FIG. 5, the strap-length-adjusting device 50 constructed according to a second preferred embodiment of the present invention is different from the aforementioned preferred embodiments by that there are two horizontal through holes 52A and 52B formed on the main body 51 and there are four chutes 53A and 53B, each two of which are formed at two sides of the horizontal through hole 52A(52B) for inserting two partitions 54A and 54B. As shown in FIG. 6, when the strap body 55 is inserted into the main body 51, two bowknots 56A and 56B can be formed by pulling four parts of the strap body 55 out of the main body 51. Alternatively, the number of the horizontal through hole 14 can be more than two, and therefore the bowknots will be increased corresponding to the number of the horizontal through hole 14.

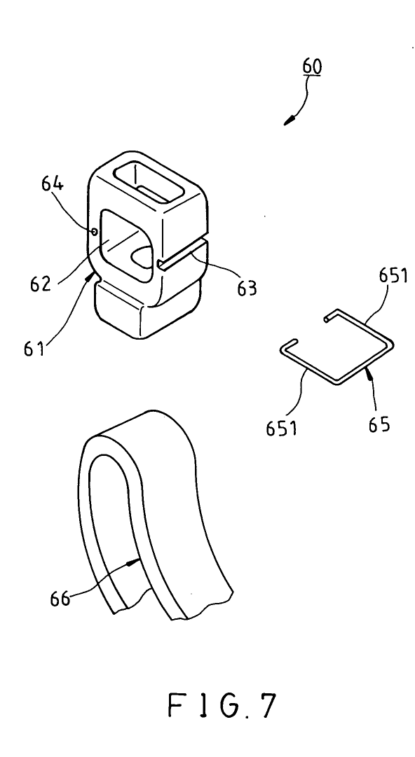

Referring to FIG. 7, the strap-length-adjusting device 60 constructed according to a third preferred embodiment of the present invention is different from the aforementioned preferred embodiments by that the partition 65 is a C-shaped annular member and the main body 61 has a ditch 63 formed at an external surface of a side thereof and a locating hole 64 formed at the other side thereof for holding two distal ends of the partition, such that two fenders 651 are formed at two ends of the horizontal through hole 62 to also prevent the two parts of the strap body 66 from pulling back inside the main body 61.

In conclusion, the present invention includes three advantages as follows.
1. The present invention is structurally simple and is very convenient and rapid to adjust the length of the strap body.
2. After the length of the strap body is adjusted, the pretty bowknot is formed to enable the present invention to look aesthetically nice.
3. The present invention can hang light items, such as name tag, whistle, mobile phone, etc. to be very practical.

1. A strap-length-adjusting device comprising:
a main body having a vertical through hole and at least one horizontal through hole, said vertical through hole being in communication with said horizontal through hole;
a strap body overlapped itself and running through said vertical through hole and having two parts pulled out of two ends of said horizontal through hole; and
at lease one partition corresponding to said horizontal through hole in number and mounted in said main body to form two fenders at two ends of said horizontal through hole, said fenders preventing said two parts of said strap body from pulling into said main body.

2. The strap-length-adjusting device as defined in claim 1, wherein said main body is composed of a flat-pillar-shaped first torso and a flat-pillar-shaped second torso, said first torso having a long axle perpendicular to that of said second torso.

3. The strap-length-adjusting device as defined in claim 1, wherein said partition is a plate member; said main body has two chutes formed at two sides of said horizontal through hole for inserting said partition.

4. The strap-length-adjusting device as defined in claim 3, wherein said main body has a convexity formed at at least one of said two chutes; said partition has a concavity formed at at least one side thereof corresponding to said convexity.

5. The strap-length-adjusting device as defined in claim 1, wherein said horizontal through hole is more than two in number for inserting said partitions to enable said strap body to form a plurality of bowknots.

6. The strap-length-adjusting device as defined in claim 1, wherein said partition is a C-shaped annular member; said main body has a ditch formed at an external surface of a side thereof and a locating hole formed at the other side thereof for holding two distal ends of said partition, such that two fenders are formed at two ends of the horizontal through hole.
